(19) United States
(12) Patent Application Publication
(10) Pub. No.: US 2022/0138777 A1
(43) Pub. Date: May 5, 2022

(54) A METHOD AND SYSTEM OF GENERATING PREDICTIVE MODEL FOR PREDICTING CONSUMER PURCHASE BEHAVIOUR

(71) Applicant: COURSE5 INTELLIGENCE PRIVATE LIMITED, Bangalore (IN)

(72) Inventor: ZABI ULLA, Bangalore (IN)

(21) Appl. No.: 17/434,475

(22) PCT Filed: Apr. 27, 2020
(86) PCT No.: PCT/IB2020/053952

§ 371 Date: Aug. 27, 2021

(30) Foreign Application Priority Data
Feb. 27, 2019 (IN) 201941007774

(51) Int. Cl. G06Q 30/02; G06N 7/00

(52) U.S. Cl. CPC G06Q 30/0202; G06N 7/00

(57) ABSTRACT

A method and system for generating predictive model for predicting consumer purchase behaviour using the history data is disclosed herein. The method includes generating online data associated with topic related searches performed by online users. Further, ingesting the online data with prestored research data and the prestored research data indicates history data about the topic processing by the processor. Further, the method includes processing the online data with the prestored research data to determine search pattern of the online users and user-behaviour information of the online users and generating the predictive model by analysing the search pattern of the online users and user-behaviour information of the online users.

### CROSS REFERENCE TO RELATED APPLICATIONS

The present disclosure is a U.S. national phase patent application, which claims the benefit of priority from PCT application PCT/IB2020/053952 filed on Apr. 27, 2020.

### TECHNICAL FIELD

The present subject matter is related, in general, to predictive modelling, and more particularly, but not exclusively to a method and system for generating predictive model for predicting consumer purchase behaviour using the real time online data.

### BACKGROUND ART

Consumer behaviour study is another, interdisciplinary and rising science, created to analyze and predict the behaviour of the online consumers. Its fundamental wellsprings of data originate from financial aspects, brain research, human science, human studies and man-made reasoning. A century ago, most people were living in residential areas with constrained potential outcomes to leave their locale, and few different ways to fulfil their requirements. Presently, because of the quickened development of innovation and the extreme difference in way of life, customers start to have progressively various necessities. At the same time the instruments used to study their behaviour have evolved, and today databases are included in consumer behaviour research. All through time numerous models were created, first to dissect, and later to foresee the buyer conduct. Therefore, the idea of predictive model is created, and by applying it currently, organizations are attempting to comprehend and foresee the conduct of their customers.

Retail and E-commerce are one of the first industries that recognized the benefits of using predictive analytics and started to employ it. In fact, understanding of the customer is a first-priority goal for any retailer. In today's competitive business environment understanding of your customer requirement and offering the right products at right time is the key of any successful business. Due to high growth of internet, online shopping is becoming most interesting and popular activities for the consumers.

Predicting the ever-evolving consumer behaviour is one of the biggest challenges faced by marketers around the world. Well, it has always been a challenging task, but today, it is even harder as consumers are constantly being exposed to new technologies, products and even new wants.

Another challenge in the existing solutions is that predictive analytics uses historical transaction data and univariant forecasting methodologies. Further, existing solutions mainly rely on internal data sources such as sales and operations and hence uses limited source of data.

In light of the aforementioned challenges, there is a need for solution that captures internet search data on a real-time basis, process such data, and build several predictive modelling algorithms along with other data sources to address questions such as predicting future sales, explain sales surge and decline, and the like. More specifically, there is a need for holistic approach, to capture all relevant information from the internet about consumer's behaviour and perception without limiting only to consumer online search behaviour, and also to understand how online competitive marketing campaigns, product positioning, promotions, price inflation execute on digital platforms would affect such the consumer's behaviour.

### SUMMARY OF THE INVENTION

This summary is provided to introduce concepts related to systems and methods for generating a predictive model and the concepts are further described below in the detailed description. This summary is not intended to identify essential features of the claimed subject matter nor is it intended for use in determining or limiting the scope of the claimed subject matter.

In one implementation, a system for generating a predictive model is disclosed. The system comprises a processor and a memory coupled with the processor. The processor is configured to execute instructions stored in the memory to generate online data associated with topic related searches performed by online users. The processor is further configured to ingest the online data with prestored research data. The prestored research data indicates history data about the topic. Further, the processor is configured to process the online data with the prestored research data to determine search pattern of the online users and user-behaviour information of the online users. The processor is further configured to generate the predictive model by analyzing the search pattern of the online users and user-behaviour information of the online users.

In another implementation, a method of generating a predictive model is disclosed. The method comprises step of generating online data associated with topic related searches performed by online users. The method further comprises step of ingesting the online data with prestored research data. Further, the prestored research data indicates history data about the topic. The method further comprises step of processing the online data with the prestored research data to determine search pattern of the online users and user-behaviour information of the online users. Further, the method comprises step of generating the predictive model by analyzing the search pattern of the online users and user-behaviour information of the online users.

### BRIEF DESCRIPTION OF DRAWING

The detailed description is described with reference to the accompanying figures. Some embodiments of system and method in accordance with embodiments of the present subject matter are now described, by way of example only, and with reference to the accompanying figures:

FIG. 1 illustrates an environment in which the system generates a predictive model, in accordance with an embodiment of the present subject matter;

FIG. 2 illustrates detailed block diagram of the system, in accordance with an embodiment of the present application;

FIG. 3 illustrates a method of generating a predictive model, in accordance with an embodiment of the present application.

### DETAILED DESCRIPTION OF EMBODIMENTS

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, system or method that comprises a list of components or steps does not include only those components or steps but may include other components or steps not expressly listed or inherent to such setup or system or method. In other words, one or more elements in a system proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

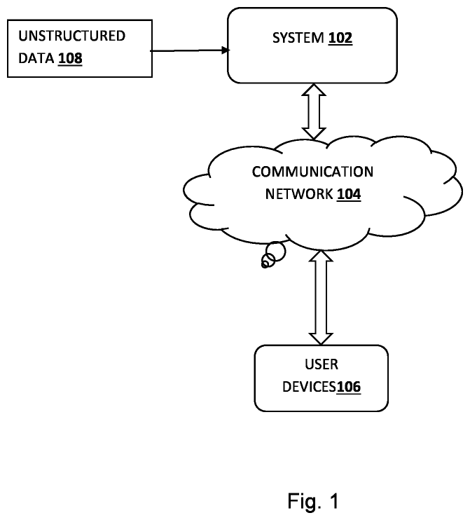

Referring to FIG. 1, an environment in which the system generates a predictive model, in accordance with an embodiment of the present subject matter. The environment comprises the system 102, communication network 104, user devices 106 and unstructured data 108. The system 102 is connected to the user devices 106 via the communication network 104. The communication network 104 may include, but is not limited to, a direct interconnection, an e-commerce network, a Peer to Peer (P2P) network, Local Area Network (LAN), Wide Area Network (WAN), wireless network (e.g., using Wireless Application Protocol), Internet, Wi-Fi and the like. The system 102 may include, but not limited to, server, computer, and portable devices. In one implementation, the system 102 may include cloud based infrastructure to enable real time processing. Further, the system 102 may be accessed by the user devices 106 associated with the user. The user device 106 may include various types of portable communication devices capable of communicating with the system 102. In one implementation, the system 102 may implemented in the user devices 106.

Initially, the system 102 captures or receives the unstructured data 108 from various online sources and stores them into its database. The system 102 further process the unstructured data 108 to generate online data for further processing. The online data indicates the structured form of the unstructured data 108. The system further processes the online data along with pre-stored research data to generate a learning mode, and thereafter, a predictive model. The predictive model generated helps the users to determine various kinds of predictive information, for example forecasting of events, reasoning of now casting, demand prediction, trends picking and the like. The detail explanation of the generating of the learning model and the predictive model is explained in the subsequent paragraphs of the specification.

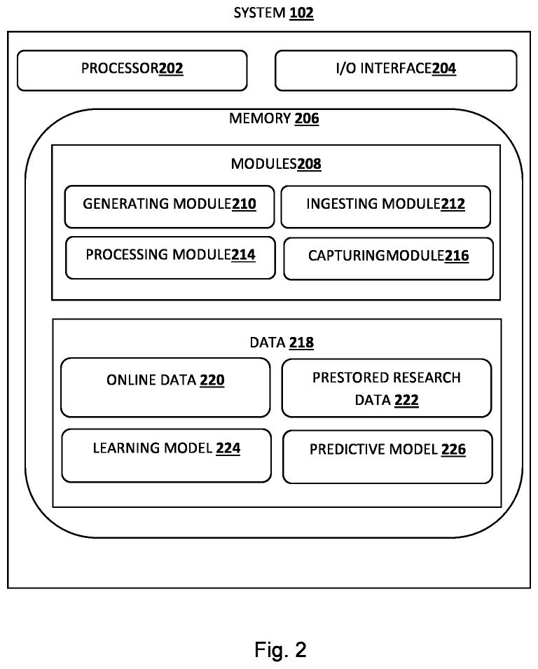

FIG. 2 illustrates detailed block diagram of the system, in accordance with an embodiment of the present application. The system 102 includes a processor 202, I/O interface 204, and a memory 206. The I/O interface 204 is configured to receive the unstructured data 108 from various online sources. The received unstructured data 108 may be stored in the memory 206 of the system 102.

The memory 206 is communicatively coupled with the processor 202 of the system 102. The memory 206 may also store processor instructions which may cause the processor 202 to execute the instructions for generating the predictive model. The memory 206 includes modules 208 and data 218.

The modules 208 include a generating module 210, ingesting module 212, processing module 214, and capturing module 216. The data 218 includes online data 220, pre-stored research data 222, learning model 224, and the predictive model 226.

In an embodiment, the capturing module 216 of the system 102 captures unstructured data 108 from a plurality of online sources. According to an embodiment, the unstructured data 108 may comprise social media data, click stream associated with online users, search data, forum data, blogs data, and email discussions and the like. In other words, the unstructured data 108 is nothing but raw data collected from various online sources which help the system 102 to understand online user's action and behaviour while searching any product/service or searching for any topic.

In next step, the generating module 210 processes the captured unstructured data 108 and generates the online data 220 associated with the topic related searches performed by online users. This helps the system 102 understand about the user behaviour and preferences while searching for any topic/product/service on internet.

In next step, the ingesting module 212 ingests the online data 220 with the prestored research data 222. According to an embodiment, the prestored research data 222 indicates history data about the topic. For example, the prestored research data 222 may include syndicated competitor's data suite which have been built and maintained from many years, which helps the system 102 understand about the past history about that topic/product/service and the like.

In nest step, the processing module 224 processes the online data 220 with the pre-stored research data 222 to determine search pattern of the online users and user-behaviour information of the online users. Further, the system 102 performs this processing step for predefined time period, for example one months, one quarter, or one year. Once the sufficient processing is done, in next system, the generating module 210 generates a learning model 224 based on the captured search pattern of the online users and the user-behaviour information of the online users for the predefined time period. The learning model 224 generated further matures over the time understand in more depth about the user behaviour and search pattern associated with the online users regarding any particular topic/product/service or any other subject for which the user may search online.

Once the learning model 224 is generated and matured, in next step, the generating module 210 further generates the predictive model 226 based on the learning model 224. Now, the predictive model 226 generated is used to determine at least one of forecasting of events in real-time, reasoning of now casting, demand prediction, and trends picking.

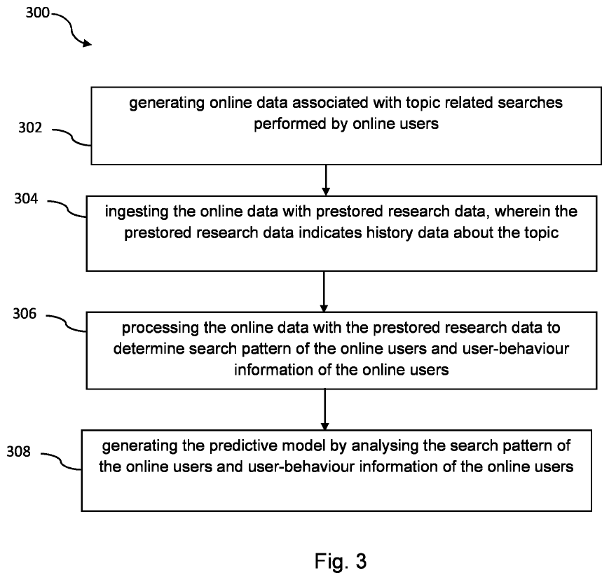

FIG. 3 illustrates a method of generating a predictive model, in accordance with an embodiment of the present application.

As illustrated in FIG. 3, the method 300 includes one or more blocks for generating the predictive model. The method 300 may be described in the general context of computer executable instructions. Generally, the computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 302, the system 102 generates, by a processor, online data 220 associated with topic related searches performed by online users.

At block 304, the system 102 ingests, by the processor, the online data 220 with prestored research data 222. The prestored research data 222 indicates history data about the topic.

At block 306, system 102 processes, by the processor, the online data 220 with the prestored research data 222 to determine search pattern of the online users and user-behaviour information of the online users.

At block 308, the system 102 generates, by the processor, the predictive model 226 by analyzing the search pattern of the online users and user-behaviour information of the online users.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method of generating a predictive model, the method comprising:
generating, by a processor, online data associated with topic related searches performed by online users;
ingesting, by the processor, the online data with prestored research data, wherein the prestored research data indicates history data about the topic;
processing, by the processor, the online data with the prestored research data to determine search pattern of the online users and user-behaviour information of the online users; and
generating, by the processor, the predictive model by analysing the search pattern of the online users and user-behaviour information of the online users.

2. The method of claim 1, wherein the online data is generated by capturing and processing unstructured data from a plurality of online sources, wherein the unstructured data comprises at least one of social media data, click stream associated with the online users, search data, forum data, blogs data, and email discussions.

3. The method of claim 1, wherein the analyzing of the search pattern and user-behaviour for generating the predictive model comprises:
capturing the search pattern of the online users and the user-behaviour information of the online users for a predefined time period; and
generating a learning model based on the captured search pattern of the online users and the user-behaviour information of the online users for the predefined time period.

4. The method of claim 1, wherein the predictive model is used to determine at least one of forecasting of events in real-time, reasoning of now casting, demand prediction, and trends picking.

5. A system for generating a predictive model, the system comprising:
a processor; and
a memory coupled with the processor, wherein the processor is configured to execute instructions stored in the memory to:
generate online data associated with topic related searches performed by online users;
ingest the online data with prestored research data, wherein the prestored research data indicates history data about the topic;
process the online data with the prestored research data to determine search pattern of the online users and user-behaviour information of the online users; and
generate the predictive model by analysing the search pattern of the online users and user-behaviour information of the online users.

6. The system of claim 5, wherein the system generates the online data is by capturing and processing unstructured data from a plurality of online sources, wherein the unstructured data comprises at least one of social media data, click stream associated with the online users, search data, forum data, blogs data, and email discussions.

7. The system of claim 5, wherein the system performs the analyzing of the search pattern and user-behaviour for generating the predictive model by,
capturing the search pattern of the online users and the user-behaviour information of the online users for a predefined time period; and
generating a learning model based on the captured search pattern of the online users and the user-behaviour information of the online users for the predefined time period.

8. The system of claim 5, wherein the predictive model is used to determine at least one of forecasting of events in real-time, reasoning of now casting, demand prediction, and trends picking.
